(19) United States
(12) Patent Application Publication
(10) Pub. No.: US 2026/0295458 A1
(43) Pub. Date: Oct. 1, 2026

(54) HIGH-TEMPERATURE INTERNAL CASCADE HEAT PUMPS FOR INDUSTRIAL MANUFACTURING APPLICATIONS ESPECIALLY DISTILLATIONS

(71) Applicant: Purdue Research Foundation, West Lafayette, IN (US)

(72) Inventors: Rakesh Agrawal, West Lafayette, IN (US); Akash Sanjay Nogaja, West Lafayette, IN (US); Priyanshu Singh, West Lafayette, IN (US)

(21) Appl. No.: 19/635,033

(22) Filed: Mar. 31, 2026

Related U.S. Application Data
(60) Provisional application No. 63/780,868, filed on Mar. 31, 2025.

(51) Int. Cl. B01D 3/00; F25B 7/00

(52) U.S. Cl. CPC B01D 3/007; F25B 7/00

(57) ABSTRACT

This disclosure relates to a heat pump configuration and associated method for pumping heat from a heat source to a heat sink, where the temperature of the heat source and the heat sink both exceed the ambient temperature. The heat pump may be used in different industrial applications, particularly in distillation systems.

### RELATED APPLICATIONS

This application claims the benefit of U.S. Provisional Application No. 63/780,868, filed Mar. 31, 2025, the entire disclosure of which is incorporated herein by reference.

### STATEMENT OF GOVERNMENT RIGHTS

This invention was made with government support under EEC-1647722 awarded by the National Science Foundation. The government has certain rights in the invention.

### BACKGROUND

With the recent focus on reducing energy consumption, one such methodology adopted in manufacturing industries is to pump heat from low-temperature heat sources to high-temperature heat sinks. In the chemical, petrochemical, food, and pharmaceutical manufacturing plants, lower temperature heat from various sources could be beneficially used by heat pumping to higher temperatures. Some examples of such sources include heat available from the exothermic reactors, condensers of the distillation columns, etc. Some examples of such heat sinks include heat to the endothermic reactors, reboilers of the distillation columns, steam generators, the absorption stripper column, etc. In such plants, heat sources of interest for heat pumping are the ones that are above ambient temperatures. If these above ambient temperature heats are not properly utilized within the plant to meet one or more energy needs and are wasted by rejection to the ambient, they result in lower process efficiency. For example, in distillation processes, heat from the condensers is often rejected to ambient through the use of cooling water.

While the use of heat pumps in the above-mentioned manufacturing plants has been suggested, the heat pumps become energy inefficient and uneconomical when the temperature difference between the sink and the source (also referred to as temperature lift) rises. Some examples in distillation application of temperature lifts being high include heat pump applications such as applying a heat pump on a fully thermally coupled column system (FTCs), or a heat pump on multi-effect columns, or from the condenser of one column to the reboiler of another column when there are multiple distillation columns to separate a multicomponent feed, etc. Generally, in all these examples, the temperature difference between the reboiler (sink) and condenser (source), i.e., temperature lift, could be greater than 50 degrees Celsius and even greater than 100 degrees Celsius. There is a need for energy-efficient and economical heat pumps for manufacturing industrial applications.

### SUMMARY

The present disclosure may comprise one or more of the following features and combinations thereof.

In one aspect, the present disclosure provides a method of pumping heat from a heat source that is above ambient temperature to a heat sink that is above the temperature of the heat source. The method may comprise (i) providing a low-pressure gaseous stream of a mixed component containing two or more components with different boiling points; (ii) compressing the low-pressure gaseous stream to increase a pressure of the low-pressure gaseous stream to provide a high-pressure stream, which is predominantly a vapor or a gaseous stream; (iii) partially condensing the high-pressure stream by transferring heat to the heat sink from the high-pressure stream to provide a partially condensed two-phase stream; (iv) performing at least one separation and intermediate condensation step in which the two-phase stream is separated into separate liquid and vapor streams and the separated vapor stream is independently condensed; (v) reducing the pressure of the condensed separated vapor stream after step (iv); (vi) vaporizing the condensed separated vapor stream of step (v) by transferring heat from the heat source to the condensed separated vapor stream to provide a vaporized stream; (vii) combining the vaporized stream with the separated liquid stream from step (iv) to provide the two-phase stream; and (viii) vaporizing the two-phase stream by transferring heat from the separated liquid stream and the separated vapor stream in step (iv) to the two-phase stream through an intermediate heat exchanger to provide the low-pressure gaseous mixed component stream of step (i).

In some embodiments, the separation and intermediate condensation step may comprise: (a) separating the partially condensed two-phase stream into two streams including a separated liquid stream rich in heavier components and a separated vapor stream rich in lighter components, (b) further cooling the separated liquid stream from step (a) by transferring heat from the separated liquid stream to a two-phase stream in the intermediate heat exchanger and reducing a pressure of the separated liquid stream, and (c) condensing the separated vapor stream from step (a) by transferring heat from the separated vapor stream to the two-phase stream through the intermediate heat exchanger to provide a condensed separated vapor stream.

In some embodiments, the method may further comprise performing an additional separation and intermediate condensation step before step (v). The method may further comprise performing any number of separation and intermediate condensation steps before step (v) based on a difference of temperature between the heat source and the heat sink. The additional separation and intermediate condensation step may comprise: (d) partially condensing the separated vapor stream in step (c) of the previous separation and intermediate condensation step (iv) and then separating the partially condensed separated vapor stream from step (c) in the previous separation and intermediate condensation step (iv) into two streams including a second separated liquid stream rich in heavier components and a second separated vapor stream rich in lighter components, (e) further cooling the second separated liquid stream from step (d) by transferring heat from the second separated liquid stream to a two-phase stream in a second intermediate heat exchanger and reducing the pressure of the second separated liquid stream, and (f) condensing the second separated vapor stream from step (d) by transferring heat from the second separated vapor stream to the two-phase stream through the second intermediate heat exchanger to provide a condensed second separated vapor stream.

In some embodiments, the method may further comprise: (ix) combining the vaporized stream with the second separated liquid stream after it is cooled and throttled to provide the two-phase stream before step (vi) and (x) vaporizing the two-phase stream from step (ix) by transferring heat from the second separated liquid stream and the second separated vapor stream to the two-phase stream from step (ix) through the second intermediate heat exchanger before step (vi).

In some embodiments, the temperature of the heat source is at least about 10 degrees Celsius above ambient temperature. In some embodiments, the temperature of the heat source is at least about 25 degrees Celsius above ambient temperature. In some embodiments, the temperature of the heat source may be more than 25 degrees Celsius above ambient temperature. In some embodiments, the temperature lift between the heat source and the heat sink may be about 100 degrees Celsius. In some embodiments, the temperature lift between the heat source and the heat sink may approach 200 degrees Celsius or higher.

In some embodiments, the heat source and the heat sink may be part of a chemical plant, a petrochemical plant, a food and beverages plant, a pharmaceutical plant, a pulp and paper plant, a plastic and textile plant, etc. For the chemical or petrochemical industry, the heat source may be an exothermic reactor, a condensing stream, a condenser of a distillation column, from a solidification of a stream, heat from a process stream that is being cooled, or waste heat. The heat sink may be an endothermic reactor, a boiling liquid stream, a melting solid, a reboiler of a distillation column, or steam generation, heating of a process stream.

In some embodiments, the heat source may be one of a top condenser of a distillation column and an intermediate condenser located in a rectifying section of the distillation column. In some embodiments, the heat sink may be one of a bottom reboiler of a distillation column and an intermediate reboiler located in a stripping section of the distillation column. In some embodiments, the heat source and the heat sink may be part of a single distillation column. In some embodiments, the heat source may be a condenser of a first distillation column and the heat sink is a reboiler of a second distillation column that is different from the first distillation column.

According to another aspect, the present disclosure provides a method of pumping heat from a heat source to a heat sink. The heat source is above ambient temperature and the heat sink is above the temperature of the heat source. The method may comprise: (i) providing a low-pressure gaseous stream of a mixed component containing two or more components with different boiling points; (ii) compressing the low-pressure gaseous stream to increase a pressure of the low-pressure gaseous stream to provide a high-pressure stream, which is predominantly a vapor or a gaseous stream; (iii) partially condensing the high-pressure stream by transferring heat to the heat sink from the high-pressure stream to provide a partially condensed two-phase stream; (iv) performing at least one separation and intermediate condensation step in which the two-phase stream is separated into separate liquid and vapor streams and the separated vapor stream is independently condensed; (v) reducing the pressure of the condensed separated vapor stream after step (iv); (vi) vaporizing the condensed separated vapor stream of step (v) by transferring heat from the heat source to the condensed separated vapor stream to provide a vaporized stream; (vii) combining the vaporized stream with the separated liquid stream from step (iv) to provide a two-phase stream; and (viii) vaporizing the two-phase stream when transferring heat from the separated liquid stream and the separated vapor stream in step (iv) to provide the low-pressure gaseous mixed component stream of step (i).

In some embodiments, the separation and intermediate condensation step may comprise: (a) separating the partially condensed two-phase stream into two streams including a separated liquid stream rich in heavier components and a separated vapor stream rich in lighter components, (b) further cooling the separated liquid stream from step (a) by transferring heat from the separated liquid stream and reducing the pressure of the separated liquid stream, and (c) condensing the separated vapor stream from step (a) by transferring heat from the separated vapor stream to provide a condensed separated vapor stream.

In some embodiments, the method may further comprise performing an additional separation and intermediate condensation step before step (v). The method may further comprise performing any number of separation and intermediate condensation steps before step (v) based on a difference of temperature between the heat source and the heat sink. The additional separation and intermediate condensation step may comprise: (d) partially condensing the separated vapor stream in step (c) of the previous separation and intermediate condensation step (iv) and then separating the partially condensed separated vapor stream from step (c) in the previous separation and intermediate condensation step (iv) into two streams including a second separated liquid stream rich in heavier components and a second separated vapor stream rich in lighter components, (e) further cooling the second separated liquid stream from step (d) by transferring heat from the second separated liquid stream and reducing a pressure of the second separated liquid stream, and (f) condensing the second separated vapor stream from step (d) by transferring heat from the second separated vapor stream to provide a condensed second separated vapor stream.

In some embodiments, the method may further comprise: (ix) combining the vaporized stream with the second separated liquid stream after step (e) to provide the two-phase stream before step (vi) and (x) vaporizing the two-phase stream from step (ix) when transferring heat from the second separated liquid stream and the second separated vapor stream to the two-phase stream from step (ix) before step (vi).

According to another aspect, the present disclosure provides a heat pump for pumping heat from a heat source to a heat sink. The heat source is above ambient temperature. The heat sink is above the temperature of the heat source. The heat pump may comprise a compressor, at least one separation and intermediate condensation unit in fluid and thermal communication with the heat sink, and an expansion valve.

In some embodiments, the compressor may be configured to compress a working fluid of a mixed component containing two or more components with different boiling points to increase the pressure of the working fluid. The compressor may be configured to compress the working fluid to increase the pressure of the working fluid before being partially condensed by transferring heat to the heat sink from the working fluid so that the working fluid becomes a two-phase stream.

In some embodiments, the separation and intermediate condensation unit may comprise a separator, an intermediate heat exchanger, and an intermediate expansion valve. The separator may be configured to separate the vapor and liquid phases of the two-phase stream of the working fluid into separate streams including a liquid stream that is rich in heavier components and a vapor stream that is rich in lighter components. The intermediate heat exchanger may be configured to transfer heat from the liquid stream and the vapor stream to condense the vapor stream and further cool the liquid stream. The intermediate expansion valve may be in fluid communication with the intermediate heat exchanger to receive the liquid stream to reduce a pressure of the liquid stream.

In some embodiments, the expansion valve may be in fluid communication with the intermediate heat exchanger to receive the condensed vapor stream to reduce the pressure of the condensed vapor stream. The expansion valve may reduce the pressure of the condensed vapor stream before being vaporized by transferring heat from the heat source to the working fluid so that the working fluid is a vaporized stream.

In some embodiments, especially pertaining to the distillation, the heat pump may further comprise a reboiler in fluid communication with the compressor and in thermal communication with the heat sink and a condenser in fluid communication with the expansion valve and in thermal communication with the heat source. The reboiler may be configured to partially condense the working fluid by transferring heat to the heat sink from the working fluid so that the working fluid becomes a two-phase stream. The condenser may be configured to vaporize the vapor stream of the working fluid by transferring heat from the heat source to the vapor stream so that the working fluid is a vaporized stream.

### BRIEF DESCRIPTION OF THE FIGURES

FIG. 1 is diagrammatic view of a single-stage high-temperature internal cascade (HTIC) heat pump configuration for pumping heat from a heat source above ambient temperature to a heat sink above the temperature of the heat source.

FIG. 2 is a diagrammatic view of a single-stage HTIC configuration with an eductor;

FIG. 3A is a diagrammatic view of a two-stage HTIC heat pump configuration;

FIG. 3B is a diagrammatic view of another embodiment of a two-stage HTIC heat pump configuration.

FIG. 4 is a diagrammatic view of a general use of HTIC heat pumps in manufacturing industries.

FIG. 5 is a diagrammatic view of the use of the HTIC heat pump in a distillation column to pump heat from a condenser of the distillation column (e.g., the heat source) to a bottom reboiler of the distillation column (e.g., the heat sink).

FIG. 6 is a diagrammatic view of the use of the HTIC heat pump in a distillation column with an intermediate condenser heat source located in the rectifying section and an intermediate reboiler heat sink located in the stripping section.

FIG. 7 is a diagrammatic view of an example of separation using two distillation columns.

FIG. 8 is a diagrammatic view of an example of a double-effect distillation for a binary feed mixture.

FIG. 9 is a diagrammatic view of a fully thermally coupled (FTC) distillation column for a four-component feed mixture separation.

### DETAILED DESCRIPTION

An object of the present disclosure is to use a high-temperature internal cascade (HTIC) heat pump for pumping heat from a heat source that is above the ambient temperature to a heat sink that is above the heat source temperature. In particular, the heat source temperature is at least a few degrees above the ambient temperature. As compared to the ambient temperature, the heat source temperature can be higher by about 10 degrees Celsius and preferably by about 25 degrees Celsius or more. As an example, for an ambient temperature of 20 degrees Celsius, the exergy content (potential to do work) of 100 kJ of heat at 30 degrees Celsius would be 3.3 kJ, and for heat at 45 degrees Celsius would be 7.86 kJ. The exergy content of the heat would increase as the temperature of the heat source rises, and it becomes important that such heat be utilized via heat pumping.

Therefore, for the above-mentioned manufacturing plants, it is essential to use energy-efficient and cost-effective heat pumps to improve the overall efficiency of manufacturing. The manufacturing sectors of interest for HTIC applications include chemical and petrochemical plants, food and beverage plants, a pharmaceutical plant, pulp and paper plants, plastic plants, and textile plants. In particular, distillations with condenser temperatures above the ambient temperature are ubiquitous in the chemical, petrochemical, food, and pharmaceutical industries and are referred to here as above-ambient temperature distillations. These distillations require heat in their bottom reboiler. Generally, the amount of heat rejected in the condenser is similar in quantity to the heat needed in the reboiler. The condenser (heat source) temperature is lower than the reboiler (heat sink) and our HTIC heat pump invention is particularly suitable for pumping heat from the condenser to the reboiler of such distillations.

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended clauses.

### Definitions

Unless otherwise defined herein, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended clauses, the singular forms “a,” “an,” and “the” include plural referents unless the context clearly dictates otherwise. It is further noted that the clauses may be drafted to exclude any optional element. As such, this statement is intended to serve as antecedent basis for use of such exclusive terminology as “solely,” “only” and the like in connection with the recitation of clause elements, or use of a “negative” limitation.

As used herein, the terms “including,” “containing,” and “comprising” are used in their open, non-limiting sense.

The term “about” as used herein means greater or lesser than the value or range of values stated by 10 percent, but is not intended to designate any value or range of values to only this broader definition. Each value or range of values preceded by the term “about” is also intended to encompass the embodiment of the stated absolute value or range of values. To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

All of the above, and any other publications, patents and published patent applications referred to in this application are specifically incorporated by reference herein. In case of conflict, the present specification, including its specific definitions, will control.

The term “mixed component” as used herein, refers to a mixture that comprises two or more components selected from the group of hydrocarbons (but not limited to it) containing one or more carbon atoms. The mixture may include: alcohols, alkanes, amines, olefins, aldehydes, freons, ketones, aromatics, etc. Besides hydrocarbons, the constituents of the mixed component may also include one or more suitable components from the list of chlorofluorocarbons (CFCs), hydrochlorofluorocarbons (HCFCs), hydrofluorocarbons (HFCs), and HFOs (organic compound composed of hydrogen, fluorine, and carbon). When HTIC is applied to a distillation, the mixed component can also contain one or more components present in the feed mixture. The mixture may also include azeotropic mixtures, polar and non-polar mixtures. The components and their composition depend upon the temperature (and their range) of heat sources and sinks. The mixture and/or its relevant submixtures exist as a liquid and/or vapor phase in the given operating range of temperature and pressure.

The term “lighter components” as used herein, refers to the constituents of the mixture that have lower boiling points and higher volatility relative to the other constituents, causing them to preferentially remain in the vapor phase upon partial condensation.

The term “heavier components” as used herein, refers to the constituents of the mixture that have higher boiling points and lower volatility relative to the other constituents, causing them to preferentially transition into the liquid phase upon partial condensation.

The term ‘boiling point’ as used herein, refers to the temperature at which a pure component's vapor pressure is equal to the atmospheric pressure.

The term “predominantly” as used herein, refers to the majority of the content of that particular stream.

The terms “rectifying” and “stripping” as used herein, refer to sections above and below the feed in the distillation column, respectively.

The term “desired location” as used herein, refers to any stage(s) in the distillation column.

The terms “condensers” and “reboilers” as used herein, refer to the heat exchangers at the top and bottom of the distillation column, respectively. Heat is added to the “reboilers” at the highest temperature, and heat is removed from the “condensers” at the lowest temperature of the distillation column.

The term “partial condensation” as used herein, refers to incomplete condensation, which results in a two-phase stream containing both vapor and liquid.

The term “pressure ratio” as used herein, refers to the ratio of the compressor's outlet and inlet pressures. All the pressure values listed are absolute pressure.

The term “throttling” as used herein, refers to the reduction of pressure.

The term “temperature lift” as used herein, refers to the temperature over which heat is pumped. If the heat pump is applied between the condenser and the reboiler of a distillation column, then the temperature lift is the difference between the reboiler and the condenser temperatures.

### Representative Embodiments

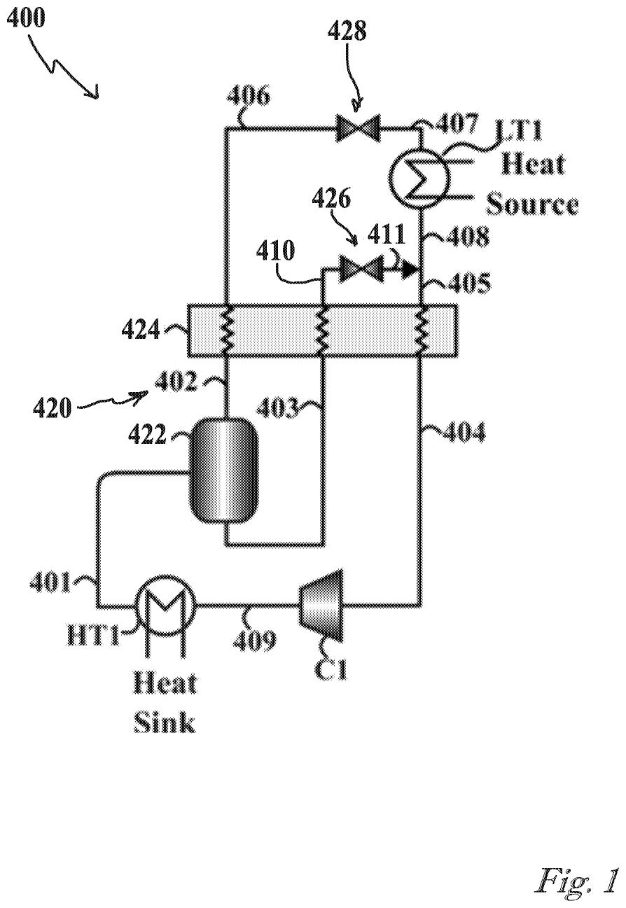

FIGS. 1-3B show embodiments of high-temperature internal cascade (HTIC) heat pump 400, 500, 600. The HTIC heat pumps 400, 500, 600 are configured to pump heat from an above-ambient temperature heat source LT1 to a heat sink HT1 that is at a temperature higher than the heat source LT1. The HTIC heat pump 400, 500, 600 utilizes the fact that partial condensation of a high-pressure mixed component vapor stream provides a two-phase stream that can be separated into a vapor stream rich in the lighter components and a liquid stream rich in the heavier components. Furthermore, the fact that each of these streams at the lower suction pressure of the heat pump compressor has different temperature ranges spanning dew and bubble points, enables the cascading of heat from the heat source to the heat sink.

Typical heat pumps or heat pump loops, more specifically in the context of distillation, have a condenser serving as the source and a reboiler as the heat sink. In such embodiments, a vapor stream is first compressed in compressor and then completely condensed by providing heat in the reboiler. The resulting stream is subcooled in a heat exchanger and throttled across an expansion or throttle valve (e.g. a Joule-Thompson valve) to give a stream, which is generally two-phase but predominantly liquid. This liquid stream is then vaporized against the source stream, e.g., a condenser of the distillation column. This vaporized stream, which is predominantly vapor, is superheated in the heat exchanger against the subcooling stream. It results in the superheated vapor, which is then compressed to complete the cycle.

The issue with a single heat pump loop for large temperature lift applications (e.g., distillation column applications), is its infeasible large pressure ratio across the compressor, as well as the possibility of the heat pump streams going into either a critical region at the compressor discharge or a very low-pressure region at the compressor inlet. For example, applying heat pumps on a distillation column that separates hexane-hexadecane (see Example 1), the temperature difference between the reboiler and condenser may be about 200 degrees Celsius. With undecane (C₁₁) as the heat pump fluid, the throttling pressure exiting expansion valve becomes 0.01 bar absolute, with a pressure ratio of 365 across the heat hump compressor. Such a low throttling pressure is impractical, as there would be additional pressure drops in the pipes, heat exchangers, etc., which can further increase the pressure ratio.

Heat pumps with multiple cascading loops solve the above-discussed challenges associated with larger temperature lifts by using compressor in each of the cascading loop. Each compressor pressurizes and heats the refrigerant of the respective loop, which is then transferred to the next loop to achieve the desired temperature lift. The heat exchanger of the intermediate loop occurs at a temperature range intermediate to the heat source and the heat sink temperatures, until the desired temperature lift is achieved. However, the use of multiple compressors contributes to added cost and maintenance of additional rotating machines.

Auto cascade heat pump (ACHP) cycles may be to transfer heat from the ambient environment to residential buildings in cold regions of the world. These air-source heat pumps may transfer heat from cold ambient temperatures (heat source) of −10 degrees Celsius to heat sink temperatures of 50 degrees Celsius to 75 degrees Celsius. However, the heat source is typically at cold ambient temperatures and may only be able to manage minimal temperature lift between the heat source and the heat sink. Similar cycles have also been used in Auto Cascade Refrigeration (ACR) cycles, but are used to cool indoor spaces to low- or ultra-low temperatures to liquify a gaseous stream such as methane. Even still, in ACR cycles, the heat source is well below the ambient temperature, and the heat sink is at the ambient temperature.

FIG. 1 shows a HTIC heat pump 400 according to the current invention for pumping heat from an above-ambient temperature heat source LT1 to a heat sink HT1 that is at a temperature higher than the heat source LT1. The heat pump 400 includes a compressor C1, a separation and intermediate condensation unit 420, an expansion or throttling valve 428, and fluid lines in fluid communication therebetween as shown in FIG. 1. The separation and intermediate condensation unit 420 is configured to separate vapor and liquid fractions of the two-phase mixed component working fluid and condense the separated vapor stream and further cool the separated liquid stream independently to achieve the desired temperature lift between the heat source LT1 and heat sink HT1. In distillation applications, the desired temperature lift may be greater than 25 degrees Celsius. In some embodiments, the desired temperature lift may be between about 100 to 200 degrees Celsius.

The separation and intermediate condensation unit 420 has a separator 422, a heat exchanger 424, and an expansion or throttling valves 426 as shown in FIG. 1. The separator 422 is configured to separate a two-phase stream into two streams: a vapor stream 402 which is richer in lighter components and a liquid stream 403 which is richer in heavier components. The heat exchanger 424 is configured to transfer heat from different streams to further cool the separated liquid stream and condense the separated vapor stream. The expansion or throttle valves 426, 428 are both configured to reduce the pressure of the respective stream.

During operation, a low-pressure gaseous stream 404 of a mixed component is first compressed in the heat pump compressor C1 to provide a high-pressure stream 409 of the mixed component. The high-pressure stream 409 is then partially condensed by transferring heat from the high-pressure stream 409 to the heat sink HT1 across a heat exchanger, resulting in a partially condensed two-phase stream 401. The separation and intermediate condensation unit 420 then separates the partially condensed two-phase stream 401 and separately further cools the separated liquid stream 403 and condenses the separated vapor stream 402. As shown in FIG. 1, the partially condensed two-phase stream 401 is separated into a vapor stream 402, rich in lighter components, and a liquid stream 403, rich in heavier components by the separator 422.

The separated vapor stream 402 is condensed in the intermediate heat exchanger 424 to provide condensed separated vapor stream 406 as shown in FIG. 1. The pressure of the condensed separated vapor stream 406 is reduced across the expansion valve 428 to provide the stream 407. The stream 407 is then vaporized by transferring heat from the heat source LT1 to the stream 407 across a heat exchanger to provide a vaporized stream 408.

The separated liquid stream 403 is further cooled in the intermediate heat exchanger 424 to provide subcooled separated liquid stream 410 as shown in FIG. 1. The pressure of the subcooled separated liquid stream 410 is reduced across the expansion valve 426 to provide a low-pressure stream 411. Once the subcooled separated liquid stream 410 is throttled, the low-pressure stream 411 is mixed with the vaporized stream 408 after the heat exchange with the heat source LT1 to provide the two-phase stream 405.

The two-phase stream 405 is heated in the intermediate heat exchanger 424 as shown in FIG. 1. The heat from the separated vapor stream 402 and the separated liquid stream 403 is transferred to the two-phase stream 405 in the heat exchanger 424 to provide the low-pressure gaseous stream 404. The low-pressure gaseous stream 404 may be a saturated vapor stream or a superheated gaseous stream; however, here, it is referred to as a gaseous stream. The use of partial condensation at the heat sink HT1 and the use of the intermediate heat exchanger 424 for vaporization, condensation, and further cooling of the respective streams 405, 402, 403 at the intermediate temperatures enables the cascading of heat from the heat source LT1 to the heat sink HT1.

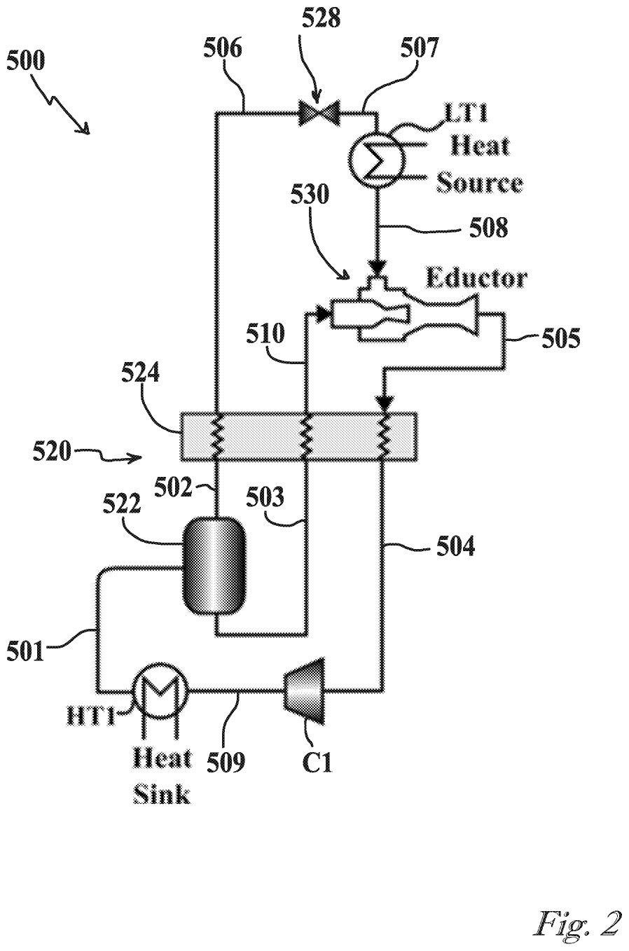

Another embodiment of a HTIC heat pump 500 is shown in FIG. 2. The HTIC heat pump 500 is substantially similar to the HTIC heat pump 400 shown in FIG. 1 and described herein. Accordingly, similar reference numbers in the 500 series indicate features that are common between the HTIC heat pump 400 and the HTIC heat pump 500. The description of the HTIC heat pump 400 is incorporated by reference to apply to the HTIC heat pump 500, except in instances when it conflicts with the specific description and drawings of the HTIC heat pump 500.

The heat pump 500 includes a compressor C1, a separation and intermediate condensation unit 520, an expansion valve 528, and fluid lines in fluid communication therebetween as shown in FIG. 2. The separation and intermediate condensation unit 520 has a separator 522 and an intermediate heat exchanger 524 like the separation and intermediate condensation unit 420 in FIG. 1. However, the separation and intermediate condensation unit 520 also includes an eductor 530 as shown in FIG. 2. The eductor 530 replaces the valve 426 and mixes the subcooled liquid stream 510 from the separator 522 with the vaporized stream 508 from the heat source heat exchanger LT1.

During operation, a low-pressure gaseous stream 504 of the mixed component is first compressed in the heat pump compressor C1 to provide a high-pressure stream 509 of the mixed component. The high-pressure stream 509 is then partially condensed by transferring heat from the high-pressure stream 509 to the heat sink HT1, resulting in a partially condensed two-phase stream 501. The separation and intermediate condensation unit 520 then separates the partially condensed two-phase stream 401 and separately further cools separated liquid stream 503 and condenses separated vapor stream 502. As shown in FIG. 2, the partially condensed two-phase stream 501 is separated into a vapor stream 502, rich in lighter components, and a liquid stream 503, rich in heavier components by the separator 522.

The separated vapor stream 502 is condensed in the intermediate heat exchanger 524 to provide condensed separated vapor stream 506 as shown in FIG. 2. The pressure of the condensed separated vapor stream 506 is reduced across the expansion valve 528 to provide the stream 507. The stream 507 is then vaporized by transferring heat from the heat source LT1 to the stream 507 to provide a vaporized stream 508.

The separated liquid stream 503 is further cooled in the intermediate heat exchanger 524 to provide subcooled separated liquid stream 510 as shown in FIG. 2. The pressure of the subcooled separated liquid stream 510 is reduced across the eductor 530. Simultaneously, the suction nozzle of the eductor 530 sucks the vaporized stream 508 that comes after the heat exchange with the heat source LT1 and mixes the vaporized stream 508 with the liquid stream 510. This results in the two-phase stream 505 exiting the eductor 530 to be at a slightly higher pressure than the corresponding stream 405 in FIG. 1, thereby improving the efficiency of the heat pump 500.

The two-phase stream 505 is heated in the heat exchanger 524 as shown in FIG. 2. The heat from the separated vapor stream 502 and the separated liquid stream 503 is transferred to the two-phase stream 505 in the heat exchanger 524. This provides the low-pressure gaseous stream 504 which is provided to the compressor C1.

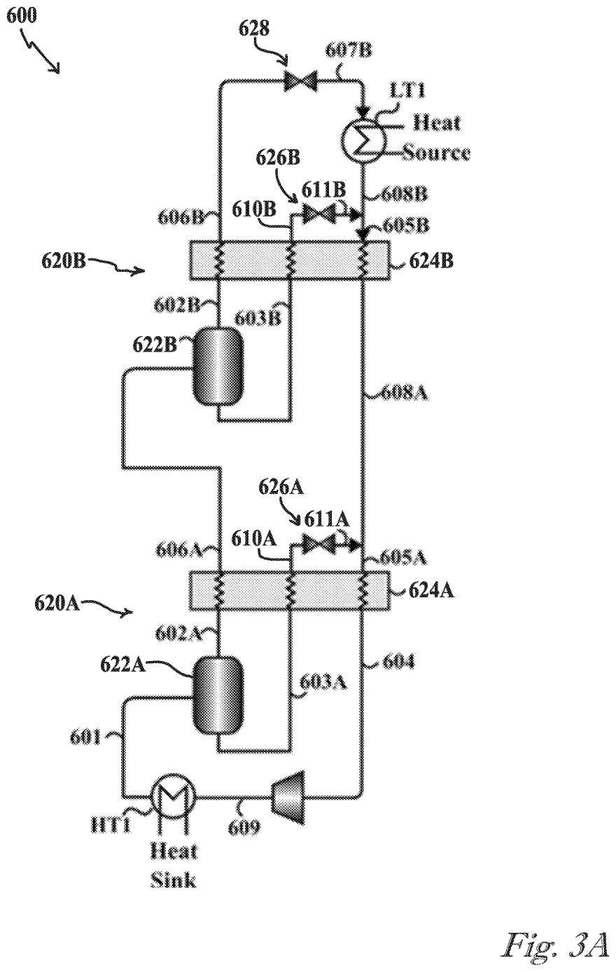

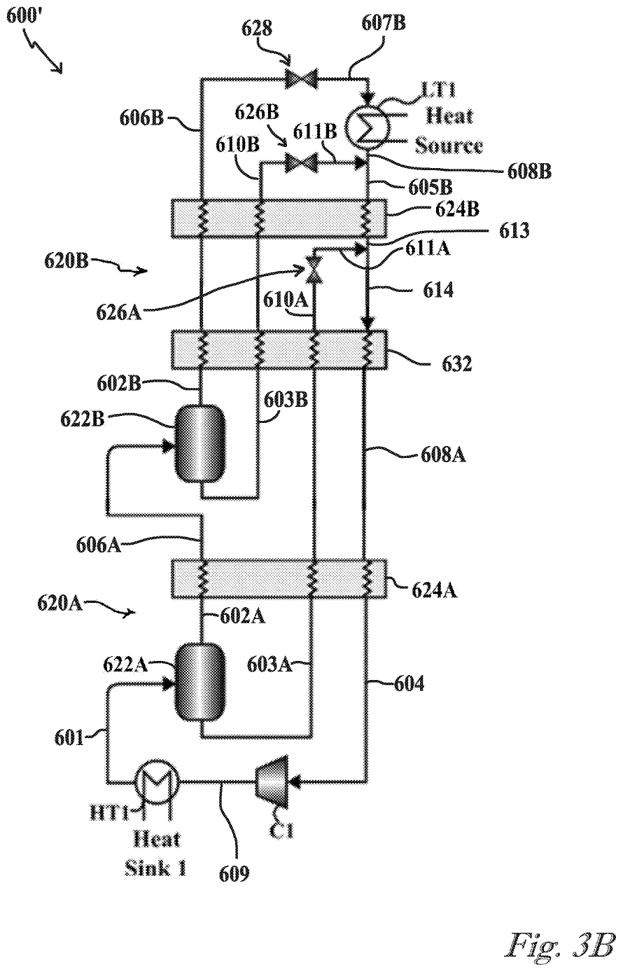

Another embodiment of a HTIC heat pump 600 is shown in FIG. 3A. The HTIC heat pump 600 is substantially similar to the HTIC heat pump 400 shown in FIG. 1 and described herein. Accordingly, similar reference numbers in the 600 series indicate features that are common between the HTIC heat pump 400 and the HTIC heat pump 600. The description of the HTIC heat pump 400 is incorporated by reference to apply to the HTIC heat pump 600, except in instances when it conflicts with the specific description and drawings of the HTIC heat pump 600.

In the embodiment of FIG. 1, the heat cascading is done at one intermediate temperature. However, when the temperature lift (e.g., the difference between the heat sink HT1 and the heat source LT1) is somewhat large, it may be advantageous to use more than one intermediate temperature for cascading. The heat pump 600 includes multiple separation and intermediate condensation units 620A, 620B as shown in FIG. 3A, which performs multiple condensations and evaporations of the mixed component from the heat pump compressor C1 to achieve the desired temperature lift.

FIG. 3A is an illustrative embodiment of a heat pump 600 that performs two partial condensations of the high-pressure mixed component stream 609. The heat pump 600 includes a compressor C1, separation and intermediate condensation units 620A, 620B, an expansion valve 628, and fluid lines in fluid communication therebetween as shown in FIG. 3A. Each separation and intermediate condensation unit 620 has a separator 622A, 622B, a heat exchanger 624A, 624B, and an expansion valve 626A, 626B as shown in FIG. 3A.

During operation, a low-pressure gaseous stream 604 of the mixed component is first compressed in the heat pump compressor C1 to provide a high-pressure stream 609 of the mixed component. The high-pressure stream 609 is then partially condensed. The high-pressure stream 609 is then partially condensed by transferring the desired heat from the high-pressure stream 609 to the heat sink HT1, resulting in a partially condensed two-phase stream 601.

The first separation and intermediate condensation unit 620A then separates the partially condensed two-phase stream 601 and separately condenses the separated vapor stream 602A and further cools separated liquid stream 603A. As shown in FIG. 3A, the partially condensed two-phase stream 601 is separated into a first separated vapor stream 602A and a first separated liquid stream 603A by the separator 622A. The first separated vapor stream 602A is rich in lighter components, similar to the stream 402 in FIG. 1, and the first separated liquid stream 603A is rich in heavier components.

To get one additional cascading temperature, the first separated vapor stream 602A is now partially condensed in the first intermediate heat exchanger 624A to provide the second two-phase stream 606A. This second two-phase stream 606A is then separated and is heat exchanged again in the second separation and intermediate condensation unit 620B. The second two-phase stream 606A is separated in the second separator 622B to provide a second separated vapor stream 602B and a second separated liquid stream 603B as shown in FIG. 3A. The second separated vapor stream 602B is richer in the lighter components than the first separated vapor stream 602A. Similarly, the second separated liquid stream 603B will be richer in the lighter components than the first separated liquid stream 603A.

The second separated vapor stream 602B is then completely condensed in the second intermediate heat exchanger 624B to provide liquid stream 606B as shown in FIG. 3A. The liquid stream 606B is treated analogously to the liquid stream 406 in the embodiment of FIG. 1 to receive heat from the heat source LT1 and provide predominantly vaporized stream 608B (stream similar to stream 408 in FIG. 1). As shown in FIG. 3A, the pressure of the condensed separated vapor stream 606B is reduced across the expansion valve 628 to provide the stream 607B. The stream 607B is then vaporized by transferring heat from the heat source LT1 to the stream 607B to provide a vaporized stream 608B as shown in FIG. 3A. The heat from the second separated vapor stream 602B and the second separated liquid stream 603B is transferred to the two-phase stream 605B in the second intermediate heat exchanger 624B.

The second separated liquid stream 603B is cooled in the second intermediate heat exchanger 624B to provide a subcooled second separated liquid stream 610B as shown in FIG. 3A. The subcooled second separated liquid stream 610B is then throttled, or reduced in pressure, across the expansion valve 626B to provide a low-pressure stream 611B. Once the subcooled separated liquid stream 610B is throttled, the low-pressure stream 611B is mixed with the vaporized stream 608B after the heat exchange with the heat source LT1 to provide the two-phase stream 605B.

The two-phase stream 605B is vaporized in the second intermediate heat exchanger 624B to provide predominantly vapor stream 608A as shown in FIG. 3A. The first separated liquid stream 603A, rich in heavier components from the separator 622A, is cooled in the first intermediate heat exchanger 624A to provide a subcooled second separated liquid stream 610A. The subcooled second separated liquid stream 610A is reduced in pressure across the expansion valve 626A to provide a low-pressure stream 611A, which is then mixed with stream 608A to provide a two-phase stream 605A.

This two-phase stream 605A is treated analogous to stream 405 in FIG. 1. The two-phase stream 605A is heated or vaporized in the first intermediate heat exchanger 624A. The heat from the first separated vapor stream 602A and the separated liquid stream 603A is transferred to the two-phase stream 605A in the heat exchanger 624A. This provides the low-pressure gaseous stream 604 which is provided to the compressor CL.

Due to two partial condensations in FIG. 3A, the resulting liquid stream 606B after the second intermediate heat exchanger 624B would be richer in lighter components as compared to the analogous liquid via one condensation process. As a result, the liquid stream 606B will be able to pick heat more efficiently from the heat source LT1 that is relatively at a much lower temperature than the heat sink HT1 temperature. Depending upon the desired temperature lift, such partial condensation can be repeated multiple times.

In such cases, the heat pump may have more than two separation and intermediate condensation units 620A, 620B. Further partial condensations followed by a final total condensation would eventually result in a liquid stream that is much richer in the lighter components and would be able to pick up heat from the heat source LT1, which is at much lower temperatures than the heat sink HT1 temperatures. In most industrial applications, one or two partial condensations may be enough to provide optimal heat pumping; however, when the desired temperature lifts are large, more than two partial condensations may provide efficient optimal heat pumping.

Another alternative heat pump 600′, similar to the heat pump 600 in FIG. 3A, is shown in FIG. 3B, where the liquid separated by the first separator 622A is not mixed with the stream 608A. Instead, the heat pump 600′ further includes a third intermediate heat exchanger 632 to further cool the separated liquid stream 603A. The separated liquid stream 603A is then mixed with the warming stream 613 from the second intermediate heat exchanger 624B before the third intermediate heat exchanger 632. The resulting stream 614 is then heated in the third intermediate heat exchanger 632 to provide the predominantly vapor stream 608A as shown in FIG. 3B. By including the third intermediate heat exchanger 632, some heat from condensing the second separated vapor stream 602B is transferred to a portion of the vaporizing liquid 603A from the first separator 622A.

The second separated vapor stream 602B is partially condensed in the third intermediate heat exchanger 632 before being fully condensed in the second intermediate heat exchanger 624B to provide liquid stream 606B as shown in FIG. 3B. The stream 606B is reduced across the expansion valve 628 to provide the stream 607B, which is vaporized by transferring heat from the heat source LT1 to the stream 607B to provide a vaporized stream 608B as shown in FIG. 3B.

The second separated liquid stream 603B is cooled in the third intermediate heat exchanger 632 before being further cooled in the second intermediate heat exchanger 624B to provide the subcooled second separated liquid stream 610B as shown in FIG. 3B. The subcooled second separated liquid stream 610B is then throttled, or reduced in pressure, across the expansion valve 626B to provide a low-pressure stream 611B. Once the subcooled separated liquid stream 610B is throttled, the low-pressure stream 611B is mixed with the vaporized stream 608B after the heat exchange with the heat source LT1 to provide the two-phase stream 605B.

As shown in FIG. 3B, the two-phase stream 605B is heated in the third intermediate heat exchanger 632 to provide a stream 613. The first separated liquid stream 603A, rich in heavier components from the separator 622A, is cooled in the first intermediate heat exchanger 624A and then the third intermediate heat exchanger 632 to provide the subcooled second separated liquid stream 610A. The subcooled second separated liquid stream 610A is reduced in pressure across the expansion valve 626A to provide a low-pressure stream 611A, which is then mixed with stream 613 to provide the stream 614 as shown in FIG. 3B.

The stream 614 is again partially vaporized in the third intermediate heat exchanger 632 to provide a two-phase stream 608A as shown in FIG. 3B. The heat from the second separated vapor stream 602B, the second separated liquid stream 603B, and the first separated liquid stream 603A is transferred to the stream 614 in the heat exchanger 632. The resulting stream 608A is further heated or vaporized in the first intermediate heat exchanger 624A. The heat from the first separated vapor stream 602A and the separated liquid stream 603A is transferred to the two-phase stream 608A in the heat exchanger 624A. This provides the low-pressure gaseous stream 604 which is provided to the compressor C1.

For convenience, the heat pump 400 and process in FIG. 1 with one cascading stage will be referred to as a one-stage HTIC heat pump cycle, while the heat pump 600 and process in FIG. 3 with two cascading stages will be referred to as a two-stage HTIC heat pump cycle. In other words, if in an HTIC heat pump cycle, n cascading stages are present, we will refer to it as n-stage HTIC heat pump cycle. The number of cascading stages will depend on the desired temperature lift between the heat sink HT1 and the heat source LT1.

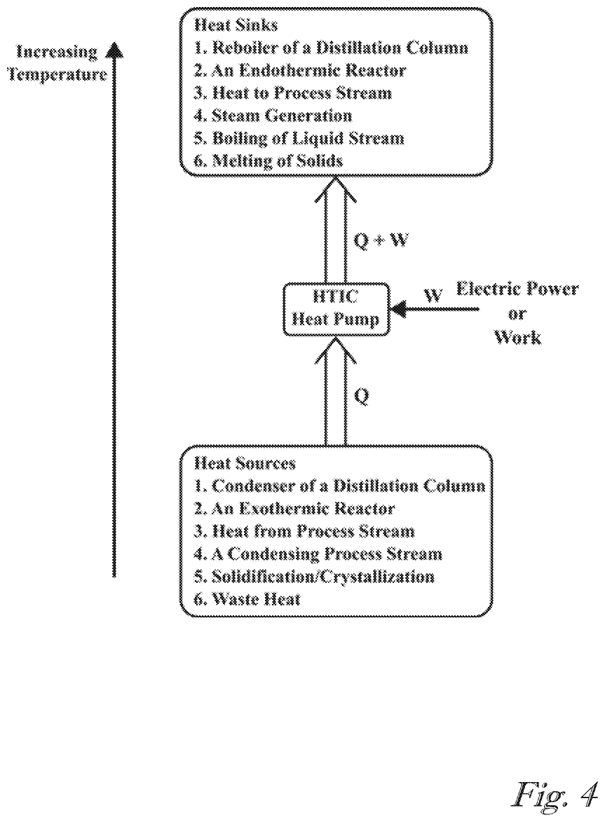

FIG. 4 shows the general use of the HTIC heat pumps (e.g., heat pumps 400, 500, 600) in different industrial applications or manufacturing industries. For example, the heat pumps 400, 500, 600 may be used with the heat sink(s) and the heat source(s) located in chemical, petrochemical, food and beverages, pharmaceutical, metal, plastic, textile, and/or wood plants. In a chemical or a petrochemical plant, multiple heat sources are available including: (i) condensers of distillation columns, (ii) exothermic reactors (e.g., fermenters, synthesis gas to methanol, Fischer Tropsch reactors, methanol to dimethyl ether, methanol to gasoline, Haber Brosch reactors for ammonia synthesis, etc.), (iii) heat from process streams being cooled, (iv) condensing streams, (v) from solidification/crystallization of a stream, (vi) a waste heat, etc. Similarly, there are various heat sinks, including: (i) reboilers of distillation columns, (ii) endothermic reactors (e.g., naphtha crackers, catalytic reforming reactors, etc.), (iii) boiling liquid streams, (iii) melting solids, (iv) steam generators, (v) heating of process streams, etc.

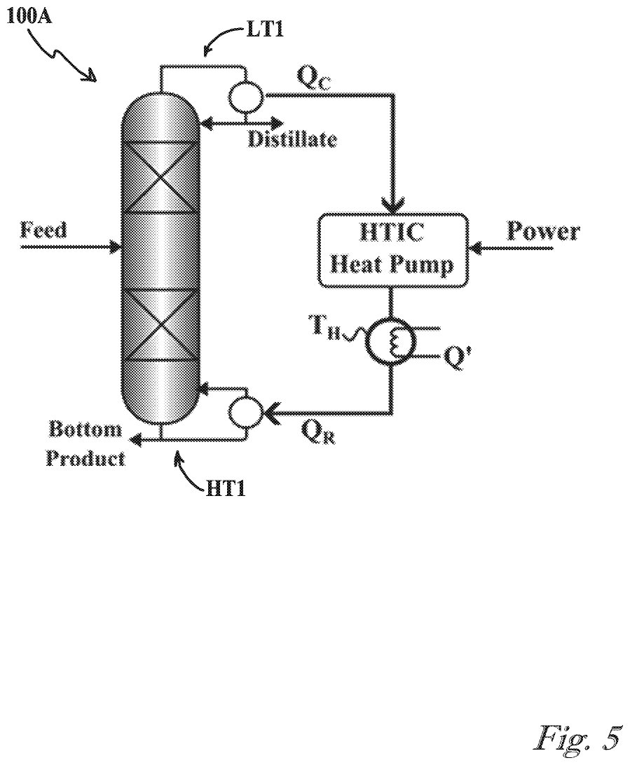

Among the above ambient temperature industrial applications, distillation separations may be of special importance. Distillation is the workhorse of separations, accounting for 90%-95% of liquid phase separations and 2.5% of the total energy used in the United States. FIG. 5 shows an illustrative example of the use of the HTIC heat pumps according to the present disclosure, where heat Q_{C} from the condenser of the distillation column 100A (e.g., the heat source LT1) is heat pumped using the HTIC heat pump 400, 500, 600 to supply heat Q_{R} to the bottom reboiler (e.g., the heat sink HT1).

In some embodiments, the system may also include a trim heat exchanger T_{H} as shown in FIG. 5. The trim heat exchanger T_{H} is configured to balance the heat load of the process. For a given distillation column 100A, the heat duties for the condenser LT1 and the reboiler HT1 are quite similar. Therefore, when the heat Q_{C} is approximately equal to the supply heat Q_{R}, the added heat pump power W_{HP} in the heat pump compressor C1 leads to an increase in the availability of heat (Q_{C}+W_{HP}) which is higher than the desired amount of Q_{R}, and this excess heat Q′ is removed in the trim heat exchanger T_{H}.

The location of the trim heat exchanger T_{H} is optional and will vary from application to application. As shown in FIG. 5, the trim heat exchanger T_{H} may be located just before the reboiler HT1. Alternatively, the trim heat exchanger T_{H} could be located anywhere after supplying heat in the reboiler HT1. In this case, the trim heat exchanger T_{H} could be immediately after the reboiler HT1, just before the condenser LT1, or even part of the condenser heat exchanger LT1. When the supply heat Q_{R} to the reboiler HT1 is substantially greater than the heat Q_{C} from the condenser LT1, heat may be added to the reboiler HT1 via the trim heat exchanger T_{H}. Similarly, if heat Q_{C} from the condenser LT1 turns out to be sufficiently greater than the supply heat Q_{R} to the reboiler HT1, the trim heat exchanger T_{H} could be used to remove heat from the system, and in another option, all the heat Q_{C} from the condenser LT1 may not be heat pumped to the reboiler HT1.

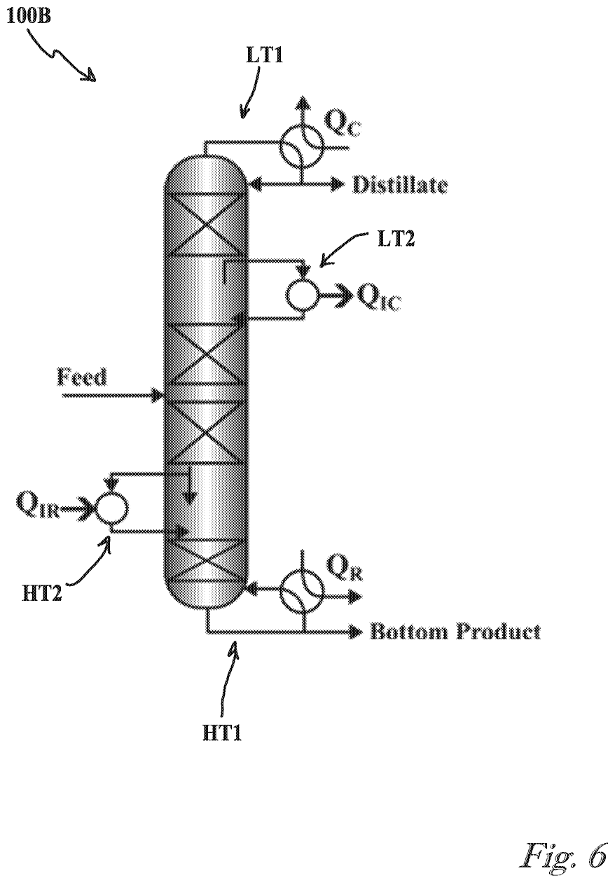

The use of intermediate condensers and intermediate reboilers may improve distillation efficiency. FIG. 6 shows an illustrative distillation column 100B with an intermediate condenser LT2 with heat duty Q_{IC} located in the rectifying section and an intermediate reboiler HT2 with heat duty Q_{IR} located in the stripping section. The HTIC heat pump cycle (e.g., heat pumps 400, 500, 600) can be used to pump heat from any of the condensers LT1, LT2 to any of the reboilers HT1, HT2 of the distillation column 100B. Alternatively, one could use two independent HTIC cycles (e.g., more than one heat pump 400, 500, 600) to pump heat from the different condensers LT1, LT2 to the different reboilers HT1, HT2 of the distillation column 100B. For example, a first HTIC heat pump may pump heat from one of the condensers LT1, LT2 to one of the reboilers HT1, HT2 and a second HTIC heat pump may pump heat from the remaining condenser(s) LT1, LT2 to the remaining reboiler(s) HT1, HT2.

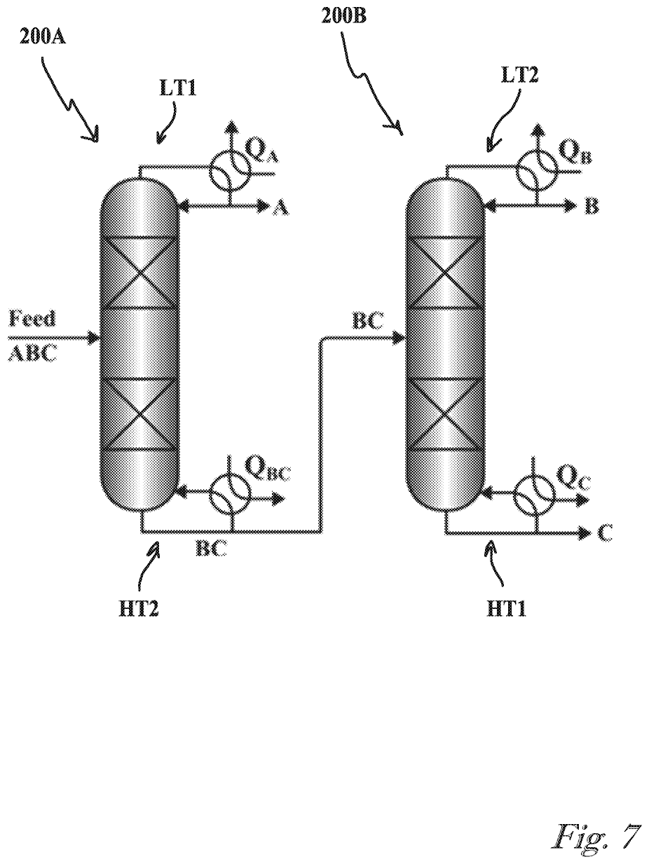

FIG. 7 shows an example of separation using two distillation columns 200A, 200B. In such an embodiment, feed mixture ABC is separated into three product streams, each enriched in one of the components A, B, C. Component A is the lightest component, component C is the heaviest component, and component B is of intermediate volatility. The HTIC heat pump cycle (e.g., heat pumps 400, 500, 600) can be used for heat pumping from any of the condensers LT1, LT2 to any of the reboilers HT1, HT2 of the distillation columns 200A, 200B. However, it may be most beneficial in the instances where heat Q_{A} is pumped from the condenser LT1 to supply heat Q_{C} to the reboiler HT2 because it would have the largest temperature lift as the temperature of the condenser LT1 would be lowest, and the temperature of the reboiler HT2 would be highest when both columns 200A, 200B are operating at similar pressures.

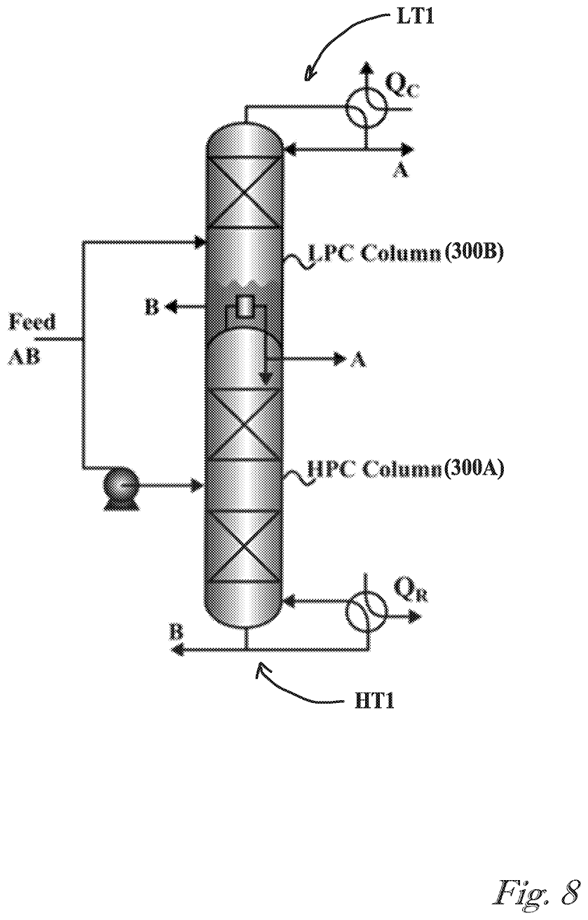

FIG. 8 shows an example of binary mixture separation using double-effect distillation. In this embodiment, the bottom high-pressure column (HPC) 300A operates at a pressure that is higher than the pressure of the low-pressure column (LPC) 300B. Due to this pressure difference, the vapor from the top of the high-pressure column 300A can be condensed by providing heat for reboiling to the bottom of the low-pressure column 300B. When compared to the single distillation column 100A, such as the one shown in FIG. 4, the use of double effect reduces the heat duty needed in the reboiler; however, the temperature lift between the condenser LT1 and the reboiler HT1 now increases. The HTIC heat pump cycle (e.g., heat pumps 400, 500, 600) may also be used for this double-effect distillation.

Additionally, multi-effect distillations that contain more than double effect may also be suitable for the application of the HTIC heat pumps 400, 500. 600. In multi-effect distillation, multiple columns are utilized at different pressures such that the condensing duty of one column occurs by providing reboiling duty to another column that is at a lower pressure. The HTIC heat pump cycle (e.g., heat pumps 400, 500, 600) may be used for pumping heat from the condenser of the low-pressure column 300B to the reboiler of the high-pressure column 300A.

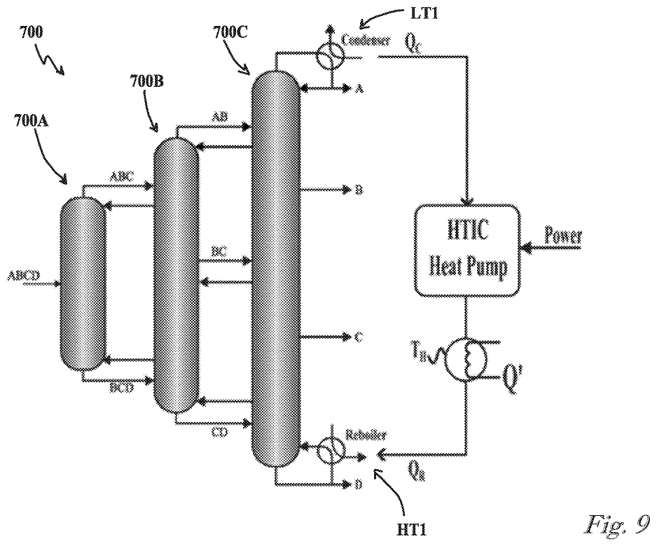

FIG. 9 shows an example of a fully thermally coupled (FTCs) column 700 for a four-component feed mixture separation into four product streams, each enriched in one of the components A, B, C, D. Where component A is the lightest component, and the volatility of the components decreases in increasing alphabetical order, with component D being the heaviest component. W_{HP}, T_{condenser}, and T_{reboiler} refer to the power work required for the heat pump 400, 500, 600 and the temperature of the condenser LT1 and reboiler HT1, respectively. The HTIC heat pump cycle (e.g., heat pumps 400, 500, 600) may be used to pump heat between the condenser associated with the lightest component and the reboiler associated with the heaviest component.

The heat pumps or heat pumping process of the present disclosure enables the pumping heat from a heat source LT1 to a heat sink LT2 when the temperature lift is greater than 25 degrees Celsius, and preferably greater than 50 degrees Celsius, and most preferably greater than 100 degrees Celsius. For example, in the case of an FTC configuration shown in FIG. 9, if A and D components were hexane and hexadecane and the columns 700A, 700B, 700C were operating close to one atmospheric pressure, the temperature difference between the reboiler HT1 for D and the condenser LT1 for A would be approximately 200 degrees Celsius. Similarly, in the case of benzene-xylene separation using a double-effect distillation like as shown in FIG. 8, when the low-pressure column LPC operates at 1.1 bar and the high-pressure column HPC operates at 5.35 bar, the temperature difference between the condenser LT1 of the low-pressure column LPC and reboiler HT1 of the high-pressure column HPC is 135 degrees Celsius. If one were to allow a 5 degrees Celsius temperature difference between the hot and cold streams in each of the two heat exchangers, the temperature lift for this application would be 145 degrees Celsius. As the temperature lift increases, it becomes more advantageous to use the HTIC heat pump cycle with two or more stages. One big advantage of the HTIC cycles is that for the same temperature lift, it provides a lower pressure ratio across the heat pump compressor. This leads to smaller and higher efficiency heat pump compressors, thereby adding to improved process efficiency and often a reduction in capital cost.

This disclosure relates to a heat pump configuration (e.g., heat pumps 400, 500, 600) in which both the heat source and heat sink temperatures exceed the ambient temperature, enabling significant temperature lift applications with a single compressor C1. This allows the pressure ratio to be in the practical range. These heat pump configurations are advantageous for numerous industrial applications, particularly in distillation systems. In numerous instances, the temperature difference between the reboiler and condenser is substantial (between 100-200 degrees Celsius), rendering a single-loop heat pump impractical, while a high-temperature internal cascade (HTIC) enables such applications.

According to the present disclosure, a high-temperature internal cascade (HTIC) heat pump cycle (e.g., heat pumps 400, 500, 600) is used to pump heat from a heat source LT1 that is above the ambient temperature to a heat sink HT1 that is above a temperature of the heat source LT1. The HTIC heat pump cycle includes: (i) providing a low-pressure gaseous mixed component stream 404, 504, 604 containing two or more components with different boiling points; (ii) compressing the low-pressure gaseous mixed component stream 404, 504, 604 to a high pressure providing the high-pressure mixed component stream 409, 509, 609, which is predominantly a vapor or a gaseous stream; (iii) partially condensing the high-pressure mixed component stream 409, 509, 609 by providing heat to the heat sink HT1 to give a partially condensed two-phase mixed component stream 401, 501, 601; (iv) separating the partially condensed two-phase mixed component stream 401, 501, 601 into two streams, a separated mixed component liquid stream 403, 503, 603A and a separated mixed component vapor stream 402, 502, 602A; (v) eventually reducing the pressure of the separated liquid stream 403, 503, 603A and vaporizing the separated liquid stream 403, 503, 603A by heat exchange (e.g., heat exchanger 424, 524, 624); (vi) partially or fully condensing the separated vapor stream 402, 502, 602A; (vii) reducing the pressure of the condensed separated vapor 406, 506, 606B stream from step (vi) and vaporing it by receiving heat from the heat source LT1; and (viii) mixing the vaporized stream 408, 508, 608A/B from step (vii) with the separated liquid stream 403, 503, 603A/B from step (iv) to provide the low-pressure gaseous mixed component stream 404, 504, 604 of step (i).

As shown in FIGS. 1-3B, the separated vapor stream 402, 502, 602A, 602B in step (vi) is either totally or partially condensed by heat exchange against the vaporizing stream 405, 505, 605A/B in step (v). The vaporized stream 408, 508, 608A/B from step (vii) is mixed with the separated liquid stream 403, 503. 603A/B in step (viii) after the pressure reduction of the separated liquid stream 403, 503, 603A/B and prior to its vaporization by heat exchange in step (v). This combined stream 405, 505, 605A/B is vaporized to provide the low-pressure gaseous mixed component stream 404, 504, 604 of step (i).

As shown in FIG. 3A, the separated vapor stream 602A from step (iv) may be partially condensed to provide a second two-phase mixed component stream 606A. The second two-phase mixed component stream 606A is separated in the second separator 622B to provide the second separated mixed component vapor stream 602B and the second separated mixed component liquid stream 603B. The second separated vapor stream 602B is then completely condensed, reduced in pressure, and vaporized by receiving heat from the heat source LT1 as shown in FIG. 3A. This vaporized stream 608B is eventually mixed with the separated liquid streams 603B, 603A from each of the partial condensation steps to provide the low-pressure gaseous mixed component stream 604 of step (i).

The pressure of the second separated liquid stream 603B is reduced and then mixed with the stream 608B vaporized by receiving heat from the heat source LT1 as shown in FIG. 3A. This combined stream 605B is vaporized by heat exchange (e.g., heat exchanger 624B) with the condensing second separated vapor stream 602B. The combined vaporized stream 608A is mixed with the separated liquid stream 603A from step (iv) and vaporized to give the low-pressure gaseous mixed component stream 604 of step (i).

In some embodiments, the heat source temperature may be higher than the ambient temperature by about 10° C. In some embodiments, the heat source temperature may be higher than the ambient temperature by about 25° C. In some embodiments, heat source temperature may be higher than the ambient temperature by more than 25° C.

In some embodiments, the heat source LT1 and the heat sink HT1 may be located in a chemical plant, a petrochemical plant, a food and beverages plant, a pharmaceutical plant, a pulp and paper plant, a plastic and textile plant, etc. For example, the pulp and paper industry uses heat at 90 degrees Celsius to 240 degrees Celsius for drying, 110 degrees Celsius to 180 degrees Celsius for cooling, and 40 degrees Celsius to 150 degrees Celsius for bleaching. Similarly, the food and beverage industry uses heat for drying, evaporation, pasteurization, sterilization, boiling, distillation, blanching etc. For chemical or petrochemical industry, the heat source may be an exothermic reactor, a condensing stream, a condenser of a distillation column, from a solidification of a stream, heat from a process stream that is being cooled, or waste heat. The heat sink may be an endothermic reactor, a boiling liquid stream, a melting solid, a reboiler of a distillation column, or steam generation, heating of a process stream.

The heat source LT1 may be one of an exothermic reactor, a condensing stream, a condenser of a distillation column, from solidification of a stream, heat from a process stream that is being cooled, a waste heat, or another suitable heat source. The heat sink HT1 may be one of an endothermic reactor, a boiling liquid stream, a melting solid, a reboiler of a distillation column, steam generation, heating of a process stream, or another suitable heat sink.

In some embodiments, the heat source LT1 may be the top condenser of a distillation column. In some embodiments, the heat sink HT1 may be the bottom reboiler of a distillation column. In some embodiments, the heat source LT1 may be an intermediate condenser located in the rectifying section of the distillation column. In some embodiments, the heat sink HT1 may be an intermediate reboiler located in the stripping section of a distillation column. In some embodiments, the heat source condenser and the heat sink reboiler may be part of the same distillation column. In some embodiments, the distillation column with heat source condenser may be different from the distillation column with the heat sink reboiler.

### EXAMPLES

The examples and preparations provided below further illustrate and exemplify particular aspects of embodiments of the disclosure. It is to be understood that the scope of the present disclosure is not limited in any way by the scope of the following examples.

### Example 1

### Hexane/Hexadecane Case

The calculation of hexane (C₆)-hexadecane (C₁₆) distillation will be treated as a base case to demonstrate the benefit of HTIC heat pumps on various fronts. As mentioned earlier, the temperature difference between the reboiler and the condenser for C₆-C₁₆ distillation is approximately 200 degrees Celsius. Table 1 lists the parameters associated with the C₆-C₁₆ distillation column. A feed of 250 km/hr with a hexane mole fraction of 0.65 was considered.

TABLE 1
Process Parameters Related to C₆-C₁₆ Distillation Case

| Heat exchangers | Heat Duty (kW) | Temperature (K) |
|---|---|---|
| Reboiler | 6982 | 445-533 |
| Condenser | 6917 | 401-342 |

Using undecane (C₁₁) as the heat pump fluid, the throttling pressure comes out as 0.01 bar, with a pressure ratio of 365. Undecane is a compound whose volatility is approximately between hexane and hexadecane. Taking a lighter compound than undecane as the heat pump fluid will increase the compressor outlet pressure, whereas taking a heavier compound than undecane as the heat pump fluid will further decrease the throttling pressure. A better way to pump heat over this large temperature lift is to use a single-stage HTIC heat pump 400 like as shown in FIG. 1 with a mixture of the compounds listed in Table 2.

TABLE 2
Mixture's Components and Mole-Fraction Used
For Single-Stage HTIC Heat Pump Calculations

| Component | Pentane | Hexane | Heptane | Pentadecane | Hexadecane | Heptadecane |
|---|---|---|---|---|---|---|
| Mole | 0.217 | 0.605 | 0.108 | 0.020 | 0.045 | 0.005 |
| fraction | | | | | | |

The components of the mixture are selected based on those that are also present in the distillation. It means that for C₆-C₁₆ distillation, hexane (C₆) and hexadecane (C₁₆) might be present in the mixture (as the heat pump fluid). Then, some components that are lighter (pentane, C₅) than the lightest component (hexane) present in the distillation and some components that are heavier (heptadecane, C₁₇) than the heaviest component (hexadecane) present in the distillation column are added. This allows the HTIC heat pump to maintain a practical pressure ratio. The exact composition is obtained by matching the temperature profile in the reboiler and the condenser. This is a general way to obtain the mixture's components but may vary case by case.

When a single-stage HTIC heat pump like as shown in FIG. 1 is used, the pressure ratio reduces to 13.6 compared to 365, with a throttling pressure of 1.1 bar. The volumetric flow rate reduces from 1.6155 to 0.6726 m³/s, which is approximately a 58% reduction, signifying a tremendous reduction in compressor size and hence its cost. The power requirement for the base case was 4158 kW, but with a single-stage HTIC heat pump, the compressor power was reduced to 3821 kW, which is an 8.1% power reduction.

Table 3 below shows the temperature, pressure, flowrate and the composition of important streams in the flowsheet shown in FIG. 1. X₁, X₂, X₃, X₄, X₅, X₆ refers to the mole fractions of pentane, hexane, heptane, pentadecane, hexadecane and heptadecane, respectively. Note that the condenser temperature range in Table 1 of about 128 degrees Celsius to about 69 degrees Celsius (501 K-342 K) is much above the typical ambient temperatures. If we take the average ambient temperature in the United States to be below 35 degrees Celsius, then a temperature of 69 degrees Celsius is at least 34 degrees Celsius above the average ambient temperature.

TABLE 3
Temperature, Pressure, Flowrate and Composition of Different
Streams of the HTIC Flowsheet for Example 1

| | Temperature | Pressure | Flowrate | Composition |
|---|---|---|---|---|
| Streams | (K) | (bar) | (kmol/hr) | X₁, X₂, X₃, X₄, X₅, X₆ |
| 409 | 547.1 | 15.0 | 990.0 | 0.217, 0.605, 0.108, 0.020, |
| | | | | 0.045, 0.005 |
| 401 | 479.0 | 15.0 | 990.0 | 0.217, 0.605, 0.108, 0.020, |
| | | | | 0.045, 0.005 |
| 407 | 335.5 | 1.1 | 666.7 | 0.254, 0.639, 0.100, 0.003, |
| | | | | 0.004, ~0.00 |
| 408 | 340.0 | 1.1 | 666.7 | 0.254, 0.639, 0.100, 0.003, |
| | | | | 0.004, ~0.00 |

### Example 2

### Double-Effect Distillation of Benzene-Xylene Mixture

As mentioned in the previous section, in the case of benzene-xylene feed separation in the double-effect distillation column, where the lower-pressure column operates at 1.1 bar, and the higher-pressure column operates at 5.35 bar, the temperature lift is around 145 degrees Celsius. Referring to FIG. 8, the following table (Table 4) lists all the parameters associated with the double-effect distillation case. A feed ratio of 1:1.02 is taken, such that the condensing duty of the HPC column is approximately equal to the reboiling duty of the LPC column.

TABLE 4
Process Parameters Related to Double-Effect Distillation Case

| Heat exchangers | Pressure (bar) | Heat Duty (kW) | Temperature (K) |
|---|---|---|---|
| LPC Condenser | 1.1 | 623.2 | 358-356 |
| HPC Reboiler | 5.35 | 814.7 | 487-491 |

If a pure fluid such as nonane (C₉) is used as the heat pump fluid, the pressure ratio is 61.88, with a throttling pressure of 0.08 bar. The volumetric flow rate across the compressor is around 8.342 m³/s.

To demonstrate the benefit of HTIC heat pump configuration on a double-effect distillation, a mixture of the composition listed in Table 5 was considered. This mixture was utilized in a two-stage HTIC heat pump like as shown in FIG. 3A, with a second-stage vapor fraction of 0.7. The second-stage vapor fraction refers to the vapor fraction of stream 606A from FIG. 3A. With these parameters, the pressure ratio reduces to 12.5, with a throttling pressure of 1.0 bar.

TABLE 5
Mixture's Components and Mole-Fraction Used
for Two-Stage HTIC Heat Pump Calculations

| Component | Pentane | Hexane | Undecane | Pentadecane |
|---|---|---|---|---|
| Mole fraction | 0.430 | 0.380 | 0.050 | 0.140 |

The volumetric flow rate for two-stage HTIC like as shown in FIG. 3A is 1.587 m³/s, which is approximately an 81% reduction. This large volumetric flowrate reduction at the inlet of the compressor will also result in a large reduction in the capital cost of the compressor. Table 6 lists the temperature, pressure, flowrate and the composition of the important streams of the flowsheet. X₁, X₂, X₃, and X₄ are the mole fractions of pentane, hexane, undecane, and pentadecane, respectively. It is to be noted that the heat source condenser temperature of 83 degrees Celsius to 85 degrees Celsius is much greater than the typical ambient temperatures.

TABLE 6
Temperature, Pressure, Flowrate and Composition of Different
Streams of the HTIC Flowsheet for Example 2

| | Temperature | Pressure | Flowrate | Composition |
|---|---|---|---|---|
| Streams | (K) | (bar) | (kmol/hr) | X₁, X₂, X₃, X₄ |
| 609 | 562.4 | 12.5 | 140.0 | 0.430, 0.380, 0.050, 0.140 |
| 601 | 512.1 | 12.5 | 140.0 | 0.430, 0.380, 0.050, 0.140 |
| 607B | 320.1 | 1.0 | 75.9 | 0.565, 0.423, 0.010, 0.003 |
| 608B | 344.4 | 1.0 | 75.9 | 0.565, 0.423, 0.010, 0.003 |

### Example 3

Single-Stage Vs. Two-Stage HTIC

To show the difference between the single-stage and the two-stage HTIC, the following mixture (shown in Table 7) as the heat pump fluid is considered as an example.

TABLE 7
Example Mixture for the Calculation to Show the
Difference in a Single-Stage and Two-Stage HTIC

| Components | Pentane | Hexane | Heptane | Octane |
|---|---|---|---|---|
| Composition | 0.25 | 0.25 | 0.25 | 0.25 |
| (mole fraction) | | | | |

This mixture is utilized on the flowsheet associated with FIGS. 1 and 3 to signify the difference between them. Table 8 below includes the process parameters for the calculations.

TABLE 8
Process Parameters Associated with Example 3

| Parameters | Value | |
|---|---|---|
| Inlet Flowrate, streams 404 and 604 | 100 | kmol/hr |
| P_{low}, pressure of streams 404 and 604 | 1.1 | bar |
| P_{high}, pressure of streams 409 and 609 | 3 | bar |
| Vapor fraction after partial condensation | 0.6 | |
| (stream 401 and stream 601) | | |

In FIG. 1, where it is a single-stage HTIC heat pump 400, the separated vapor stream 402 is completely condensed to give a liquid stream 406, also referred to as the condensed separated vapor stream 406. If this stream 406 is further subcooled and throttled back to 1.1 bar, it reaches a temperature of 336 K.

Instead of complete condensation of the separated vapor stream 402, it could be again partially condensed to create a new vapor and liquid stream like as shown in FIG. 3A. As shown in FIG. 3A, the first separated vapor stream 602A (the same as stream 402, 502) is now partially condensed to a vapor fraction of 0.8, and then the two-phase stream 606A is separated to give a second separated vapor stream 602B and second separated liquid stream 603B. This second separated vapor stream 602B will be richer in lighter components than stream 602A (or stream 402, 502). The following Table 9 lists the composition of the mixture of the streams and signifies that one stream is richer in lighter components than the other.

TABLE 9
Composition Comparison of Two Streams,

| Components | Stream 602A | Stream 602B |
|---|---|---|
| Pentane | 0.34 | 0.39 |
| Hexane | 0.29 | 0.30 |
| Heptane | 0.22 | 0.20 |
| Octane | 0.15 | 0.11 |

From the stream composition, it can be observed that second separated vapor stream 602B is richer in lighter components compared to first separated vapor stream 602A. If this stream 602B is completely condensed in the heat exchanger 624B, to produce a liquid stream of 606B and the liquid stream 606B is then further subcooled and throttled to 1.1 bar; the resulting stream 607B reaches a temperature of 333 K. It means that for the same mixture and initial process parameters, an extra partial condensation (an extra stage HTIC) leads to a drop of 3 degrees Celsius at the source side. This temperature drop can further increase if the composition is optimized appropriately or the number of partial condensations (the number of HTIC stages) is increased.

What is claimed is:

1. A method of pumping heat from a heat source that is above ambient temperature to a heat sink that is above a temperature of the heat source, the method comprising:
(i) providing a low-pressure gaseous stream of a mixed component containing two or more components with different boiling points;
(ii) compressing the low-pressure gaseous stream to increase a pressure of the low-pressure gaseous stream to provide a high-pressure stream, which is predominantly a vapor or a gaseous stream;
(iii) partially condensing the high-pressure stream by transferring heat to the heat sink from the high-pressure stream to provide a partially condensed two-phase stream;
(iv) performing at least one separation and intermediate condensation step comprising:
(a) separating the partially condensed two-phase stream into two streams including a separated liquid stream rich in heavier components and a separated vapor stream rich in lighter components,
(b) further cooling the separated liquid stream from step (a) by transferring heat from the separated liquid stream to a two-phase stream in an intermediate heat exchanger and reducing the pressure of the separated liquid stream, and
(c) condensing the separated vapor stream from step (a) by transferring heat from the separated vapor stream to the two-phase stream through the intermediate heat exchanger to provide a condensed separated vapor stream;
(v) reducing the pressure of the condensed separated vapor stream after step (iv);
(vi) vaporizing the condensed separated vapor stream of step (v) by transferring heat from the heat source to the condensed separated vapor stream to provide a vaporized stream;
(vii) combining the vaporized stream with the separated liquid stream from step (iv) to provide the two-phase stream; and
(viii) vaporizing the two-phase stream by transferring heat from the separated liquid stream and the separated vapor stream in step (iv) to the two-phase stream through the intermediate heat exchanger to provide the low-pressure gaseous mixed component stream of step (i).

2. The method of claim 1, wherein the further comprising performing an additional separation and intermediate condensation step before step (v), the additional separation and intermediate condensation step comprising:
(d) partially condensing the separated vapor stream in step (c) of the previous separation and intermediate condensation step (iv) and then separating the partially condensed separated vapor stream from step (c) into two streams including a second separated liquid stream rich in heavier components and a second separated vapor stream rich in lighter components,
(e) further cooling the second separated liquid stream from step (d) by transferring heat from the second separated liquid stream to a two-phase stream in a second intermediate heat exchanger and reducing the pressure of the second separated liquid stream, and
(f) condensing the second separated vapor stream from step (d) by transferring heat from the second separated vapor stream to the two-phase stream through the second intermediate heat exchanger to provide a condensed second separated vapor stream.

3. The method of claim 2, further comprising performing any number of separation and intermediate condensation steps before step (v) based on a difference of temperature between the heat source and the heat sink.

4. The method of claim 2, further comprising:
(ix) combining the vaporized stream with the second separated liquid stream after step (e) in the additional separation and intermediate condensation step to provide the two-phase stream before step (vi); and
(x) vaporizing the two-phase stream from step (ix) by transferring heat from the second separated liquid stream and the second separated vapor stream to the two-phase stream from step (ix) through the second intermediate heat exchanger before step (vi).

5. The method of claim 1, wherein the temperature of the heat source is at least about 10 degrees Celsius above ambient temperature.

6. The method of claim 5, wherein the temperature of the heat source is at least about 25 degrees Celsius above ambient temperature.

7. The method of claim 6, wherein the temperature of the heat source is more than 25 degrees Celsius above ambient temperature.

8. The method of claim 1, wherein the heat source and the heat sink are part of a chemical plant, a petrochemical plant, a food and beverages plant, a pulp and paper plant, a plastic plant, a textile plant, or a pharmaceutical plant.

9. The method of claim 8, wherein the heat source is an exothermic reactor, a condensing stream, a condenser of a distillation column, from a solidification of a stream, heat from a process stream that is being cooled, or waste heat.

10. The method of claim 8, wherein the heat sink is an endothermic reactor, a boiling liquid stream, a melting solid, a reboiler of a distillation column, or steam generation, heating of a process stream.

11. The method of claim 1, wherein the heat source is one of a top condenser of a distillation column and an intermediate condenser located in a rectifying section of the distillation column.

12. The method of claim 1, wherein the heat sink is one of a bottom reboiler of a distillation column and an intermediate reboiler located in a stripping section of the distillation column.

13. The method of claim 1, wherein the heat source and the heat sink are part of a single distillation column.

14. The method of claim 1, wherein the heat source is a condenser of a first distillation column and the heat sink is a reboiler of a second distillation column that is different from the first distillation column.

15. A method of pumping heat from a heat source that is above ambient temperature to a heat sink that is above a temperature of the heat source, the method comprising:
(i) providing a low-pressure gaseous stream of a mixed component containing two or more components with different boiling points;
(ii) compressing the low-pressure gaseous stream to increase the pressure of the low-pressure gaseous stream to provide a high-pressure stream, which is predominantly a vapor or a gaseous stream;
(iii) partially condensing the high-pressure stream by transferring heat to the heat sink from the high-pressure stream to provide a partially condensed two-phase stream;
(iv) performing at least one separation and intermediate condensation step comprising:
(a) separating the partially condensed two-phase stream into two streams including a separated liquid stream rich in heavier components and a separated vapor stream rich in lighter components,
(b) subcooling the separated liquid stream from step (a) by transferring heat from the separated liquid stream and reducing the pressure of the separated liquid stream, and
(c) condensing the separated vapor stream from step (a) by transferring heat from the separated vapor stream to provide a condensed separated vapor stream;
(v) reducing the pressure of the condensed separated vapor stream after step (iv);
(vi) vaporizing the condensed separated vapor stream of step (v) by transferring heat from the heat source to the condensed separated vapor stream to provide a vaporized stream;
(vii) combining the vaporized stream with the separated liquid stream from step (iv) to provide a two-phase stream; and
(viii) vaporizing the two-phase stream when transferring heat from the separated liquid stream and the separated vapor stream in step (iv) to provide the low-pressure gaseous mixed component stream of step (i).

16. The method of claim 15, further comprising performing an additional separation and intermediate condensation step before step (v), the additional separation and intermediate condensation step comprising:
(d) partially condensing the separated vapor stream in step (c) in the previous separation and intermediate condensation step (iv) and then separating the partially condensed separated vapor stream from step (c) into two streams including a second separated liquid stream rich in heavier components and a second separated vapor stream rich in lighter components,
(e) further cooling the second separated liquid stream from step (d) by transferring heat from the second separated liquid stream and reducing the pressure of the second separated liquid stream, and
(f) condensing the second separated vapor stream from step (d) by transferring heat from the second separated vapor stream to provide a condensed second separated vapor stream.

17. The method of claim 16, further comprising:
(ix) combining the vaporized stream with the second separated liquid stream after step (e) to provide the two-phase stream before step (vi); and
(x) vaporizing the two-phase stream from step (ix) when transferring heat from the second separated liquid stream and the second separated vapor stream to the two-phase stream from step (ix) before step (vi).

18. The method of claim 15, wherein the temperature of the heat source is at least about 10 degrees Celsius above ambient temperature.

19. The method of claim 18, wherein the temperature of the heat source is at least or more than 25 degrees Celsius above ambient temperature.

20. A heat pump for pumping heat from a heat source that is above ambient temperature to a heat sink that is above the temperature of the heat source, the heat pump comprising:
a compressor configured to compress a working fluid of a mixed component containing two or more components with different boiling points to increase the pressure of the working fluid before being partially condensed by transferring heat to the heat sink from the working fluid so that the working fluid is a two-phase stream;
at least one separation and intermediate condensation unit in fluid and thermal communication with the heat sink to receive the two-phase stream of the working fluid, the separation and intermediate condensation unit comprising:
a separator configured to separate the vapor and liquid phases of the two-phase stream of the working fluid into separate streams including a liquid stream that is rich in heavier components and a vapor stream that is rich in lighter components,
an intermediate heat exchanger configured to transfer heat from the liquid stream and the vapor stream to condense the separated vapor stream and further cool the separated liquid stream, and
an intermediate expansion valve in fluid communication with the intermediate heat exchanger to receive the liquid stream to reduce the pressure of the liquid stream; and
an expansion valve in fluid communication with the intermediate heat exchanger of the at least one separate and intermediate condensation unit to receive the condensed vapor stream to reduce the pressure of the condensed vapor stream before being vaporized by transferring heat from the heat source to the working fluid so that the working fluid is a vaporized stream.
